(19) United States
(12) Patent Application Publication
(10) Pub. No.: US 2010/0210292 A1
(43) Pub. Date: Aug. 19, 2010

(54) EXTENDING A TEXT MESSAGE WITH CONTENT

(76) Inventor: Eloy Johan Lambertus NOOREN, Breda (NL)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/706,590

(22) Filed: Feb. 16, 2010

Related U.S. Application Data
(60) Provisional application No. 61/152,896, filed on Feb. 16, 2009.

(51) Int. Cl. H04W 4/14

(52) U.S. Cl. 455/466

(57) ABSTRACT

A method is described for extending a text message with content wherein the text message is sent by a mobile terminal via a Short Message Service Center (SMSC) of a communications system to a recipient and wherein the communications system further comprises a Content Service Center (CSC). The method comprises the steps of receiving at the CSC the text message originating from the SMSC; generating a content-extended text message by adding at least one piece of content to at least a part of the text message; and, sending the content-extended text message depending on the size of the content-extended text message in one or more mobile terminated short messages (MT/SM) to the recipient.

### PRIORITY CLAIM

This application claims the benefit of U.S. Provisional Patent Application Ser. No. 61/152,896, filed Feb. 16, 2009; the disclosure of which is incorporated herein by reference in its entirety.

### TECHNICAL FIELD

The invention relates to extending a text message with content, and, in particular, though not exclusively, to a method and a system for extending a text message with content, a content service center for use in such system and a computer program product configured for executing such method.

### BACKGROUND

In order to generate revenue, mobile operators are continuously looking for new services. In the area of text messaging, such as the Short Message Service (SMS) and the Extended Messaging Service (EMS), one service with a strong revenue generating potential is content-extended messaging wherein content, e.g. advertisement content, is inserted into the message sent to a recipient. Messaging is a very versatile mobile advertising vehicle as it does not depend on mobile web browsing applications. The inserted content may take different forms, such as advertisement and/or other pieces of value-added information like news flashes, horoscopes, RSS feed messages, etc.

Systems for adding advertisement content to a text message are known in the prior art. One known system is based on a modified Short Message Service Centre (SMSC). Before the SMSC sends a message submitted by a subscriber registered with the advertisement service to the recipient, the modified SMSC inserts advertisement content into the text message. Another known system is described in WO2008/130565. In this document a system is described wherein mobile originated short messages (MO/SM) submitted to the SMSC by a subscriber registered with an advertisement service, are relayed to a SMS-relay platform which comprises an advertisement module configured to insert advertisement content into the message before it is forwarded to the Short Message Service Centre (SMSC).

In the GSM standard as defined in ETSI/3GPP TS 03.40 and 03.41, MO/SM messages are submitted to the home SMSC of a GSM subscriber and mobile terminated short messages (MT/SM) are delivered directly to the destination terminal identified in the MO/SM. For that reason these known systems are only capable of providing advertisement content to the messages submitted by a subscriber and not to all text messages delivered to the subscriber.

A further problem associated with these known systems relates to the fact that the GSM standard requires a message not to exceed a predetermined maximum length (size). In the GSM standard, the maximum payload is in principle 160 characters. An advertisement or another piece of value-added information however may be easily as long as or even longer than the short message itself. Hence adding information to the message will often result in a message which exceeds the maximum allowable length. For longer messages it is possible to use the so-called concatenated SMS feature as defined in the GSM standard. This feature allows the concatenation of multiple short messages. A communication system supporting concatenated messaging will divide a long text message exceeding the maximum payload into segments and insert these segments forming the (long) text message in a series of short messages, wherein each message contains a user data header (UDH) with segmentation information and a segment. These multiple short messages are sequentially sent by the SMSC to the terminal of the recipient, which is configured to assemble on the basis of the concatenation information (containing the segment number and the total number of segments) the multiple short messages into the long text message.

Combining a content service as described above with the concatenated SMS service however may result in undesired service (feature) interactions often resulting in unsuccessful or incorrect delivery of the content-extended message.

Accordingly, there exists a need for methods and systems which allow the addition of content, such as an advertisement or other pieces of information, to all text messages delivered to the mobile terminal of a subscriber registered with the content service. Moreover, there exists a need for methods and systems which are capable of generating and handling content-extended text messages which exceed a predetermined maximum size as defined in the relevant telecommunication standards.

### SUMMARY

It is an object of the invention to reduce or eliminate at least one of the drawbacks described above and to provide in a first aspect of the subject matter described herein a method for extending a text message with content wherein the text message is sent by a mobile terminal via a Short Message Service Center (SMSC) of a communications system to a recipient and wherein the communications system further comprises a Content Service Center (CSC). The method comprising the steps of: receiving at the CSC the text message originating from the SMSC; generating a content-extended text message by adding at least one piece of content to at least a part of the text message; and, sending the content-extended text message depending on the size of the content-extended text message in one or more mobile terminated short messages (MT/SM) to the recipient. The method according to the subject matter described herein allows the addition of content, e.g. in the form of an advertisement, to all text messages delivered to a recipient registered with such advertisement service without the need to modify the network elements of the communication network. Further, the method allows extension of text messages send to a recipient in single mobile terminated short message (MT/SM) or in a series of concatenated MT/SMs.

In one embodiment the method further comprises the steps of: receiving the text message in a single MT/SM; if the content-extended text message is exceeding a predetermined maximum size, dividing the content-extended text message into two or more segments, each segment being smaller than the predetermined maximum size; and, sending the segments in two or more concatenated MT/SMs, preferably using MAP MT_FW_SM messages, to the recipient. In this embodiment a content-extended message may exceed a predetermined maximum size. Therefore, the content for extending the text message may have larger size than the maximum allowable size as defined in the GSM standard.

In one embodiment the communications system further comprises a mobile switching network element, preferably a Mobile Switching Center (MSC), and wherein during the sending of the two or more concatenated SM/SMs from CSC to a mobile switching network element, the communication channel between the CSC and the mobile switching network element is kept open. Because the SMSC is not aware of the fact that the content-extended text message is sent in a series concatenated MT/SMs to the MSC and because the sending the content-extended text message in two or more concatenated MT/SMs introduces a certain delay in the transmission of the ACK to the SMSC, it is important to deliver the concatenated MT/SMs as fast as possible.

In a further embodiment the communication channel is kept open by the SCS sending a flag indicating that a further concatenated MT/SM to the network switching element, preferably the flag being a MoreMessagesToSend flag send in a MAP MT_FW_SM message comprising a concatenated MT/SM to the network switching element. Hence, this embodiment provides an efficient way of informing the mobile switching network element that the communication channel should be kept open for the transmission of a further concatenated MT/SM.

In another embodiment the method further comprises the step of the CSC sending an acknowledgement (ACK) to the SMSC if the two or more concatenated MT/SMs are successfully received by the recipient and sending a NAK if the transmission of one of the two or more concatenated MT/SMs was unsuccessful. The ACK and NAK messages inform the SMSC that whether or not transmission of the MT/SMs was successful or not. If successful, the transmission can be charged. If not successful, the SMSC may try again to send the text message to the recipient.

In yet further embodiment, the method further comprises the steps of: receiving a concatenated MT/SM originating from the SMSC, the concatenated MT/SM comprising a segment number identifying the part of the text message contained in the concatenated MT/SM and the total number of segments forming the text message sent to the SMSC; forming at least one further MT/SM comprising the content for extending the text message; sending the at least one further MT/SM and the concatenated MT/SM originating from the SMSC to the recipient as a series of concatenated MT/SMs, wherein the concatenation information of said concatenated MT/SMs is adapted such that the terminal of the recipient is capable of assembling the segments into a complete content-extended text message. Hence, by adapting the concatenation information the method allows efficient content-extension of a text message send to the recipient in a series of concatenated SM/SM.

In one embodiment, the adaptation of the concatenation information includes increasing the total number of segments and, optionally, increasing one or more segment numbers when the text message is extended by adding content to the head of the text message.

In one embodiment the communications system further comprises a network routing element, wherein the method further comprises the steps of: receiving at the network routing element a signalling message from the SMSC, the signalling message containing mobile application part (MAP) and signalling connection control part (SCCP) information; routing the signalling message to the SCS on the basis of predetermined MAP and/or SCCP information, preferably on the basis of the MAP MT_FWD_SM message. This embodiment allows simple and efficient routing of the MT/SM messages originating from the SMSC to the MT/SM proxy in the CSC.

The content for extending the text message may take various forms such as an advertisement and/or news flashes, horoscopes, RSS feed messages and other pieces of information which are of commercial interest.

In a further aspect, the subject matter described herein relates to a communications system for extending the payload of a text message sent by a subscriber from a mobile terminal to a recipient wherein the system comprises: a Short Message Service Center (SMSC); a mobile switching network element associated with the terminal of the recipient; a Content Service Center (CSC) for extending a text message originating from the SMSC with content, wherein the SCS is configured to generate a content-extended text message by adding at least one piece of content to at least a part of the text message and wherein the CSC is configured to send the content-extended text message in one or more MT/SMs via the mobile switching network element to the terminal of the recipient; and, a network routing element for routing text messages originating from the SMSC to the CSC.

In yet a further aspect the subject matter described herein relates to a content service center for extending the a text message with content for use in a system as described above wherein the content service center comprises: a receiver for receiving a text message in one or more MT/SMs originating from the SMSC; a content server interface for retrieving content from a content server; a content module configured for extending the text message with content by adding at least one piece of content to at least a part of the text message; and, a transmitter for sending the content-extended text message in one or more MT/SMs to the recipient. In one embodiment the content module is configured to divide—if the content-extended text message is exceeding a predetermined maximum size—the content-extended text message into two or more segments, each segment being smaller than the predetermined maximum size and to send the segments in two or more concatenated MT/SMs, preferably using MAP MT_FW_SM messages, to the recipient.

In another embodiment the content service center is configured to send two or more concatenated MT/SMs via a mobile switching network element to the recipient; and, to keep—during the sending of the two or more concatenated MT/SMs—the communication channel between the CSC and the mobile switching network element open, preferably using a MoreMessagesToSend flag sent in a MAP MT_FW_SM message to the mobile switching network element.

In yet another embodiment the content service center is configured to:
receive a concatenated MT/SM originating from the SMSC, the concatenated MT/SM comprising a segment number identifying the part of the text message contained in the concatenated MT/SM and the total number of segments forming the text message sent to the SMSC;
form at least one further MT/SM comprising the content for extending the text message;
send the at least one further MT/SM and the concatenated MT/SM originating from the SMSC to the recipient as a series of concatenated MT/SMs, wherein the concatenation information of said concatenated MT/SMs is adapted such that the terminal of the recipient is capable of assembling the segments into a complete content-extended text message.

The subject matter described herein also relates to a computer program product comprising software code portions configured for, when run in the memory of a content service center, executing the method steps as described above. In one exemplary implementation, the subject matter described herein can be implemented using a non-transitory computer readable medium having stored thereon executable instructions that when executed by the processor of a computer control the computer perform steps for extending text messages with content as described herein. Exemplary computer readable media suitable for implementing the subject matter described herein include chip memory devices, disk memory devices, programmable logic devices, and application specific integrated circuits.

The subject matter described herein will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1 depicts communications system according to one embodiment of the subject matter described herein;

FIG. 2 depicts a flow diagram according to one subject matter described herein wherein a text message sent in a non-concatenated MT/SM is extended with content;

FIG. 3 depicts a flow diagram according to another embodiment wherein a text message sent in a non-concatenated MT/SM is extended with content;

FIG. 4 depicts a flow diagram according to an embodiment wherein a text message sent in a series of concatenated MT/SMs is extended with content; and

FIG. 5 depicts a flow diagram according to another embodiment wherein a text message sent in a series of concatenated MT/SMs is extended with content.

### DETAILED DESCRIPTION

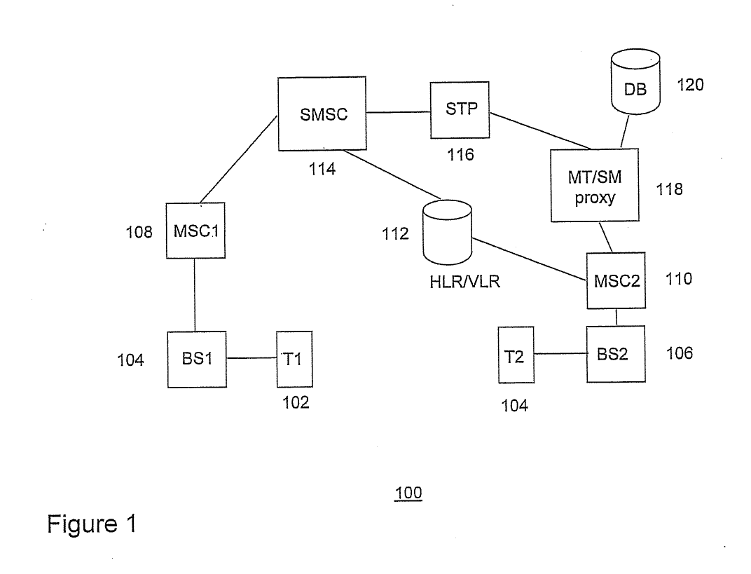

FIG. 1 depicts a schematic of a communication system 100 according to one embodiment of the subject matter described herein. In this embodiment, the system comprises a Global System for Mobile (GSM) network, which includes base stations (BS) 104,106 each associated with a Mobile Switching Center (MSC) 108,110, a Short Message Service Center (SMSC) 114 and a Visitor Location Register and Home Location Register (VLR/HRL) 112, which may be accessed by network elements such as the MSC and the SMSC. In FIG. 1 a first and second MSC are connected to a first and second base station respectively. Each base station, including an antenna tower (not shown), provides wireless network coverage for a particular coverage area commonly referred to as a “cell”. Wireless devices, in this case a first and second terminal 102,104 may register via a base station with the wireless communication system. For all wireless devices registered with a network operator, permanent data (e.g. a user profile) as well as temporary data (e.g. the current location of the wireless device) is stored in the HLR of the home network of wireless device. The VLR is responsible for a group of location areas and stores data of those wireless devices that are currently in its area of responsibility. Instead of a GSM type network as depicted in FIG. 1, other communications networks such as a GPRS or UMTS network comprising a Serving GPRS Support Node (SGSN) or an IP Multimedia Subsystem (IMS) type network comprising IMS network elements such as a Call Session Control Function (CSCF) may be used.

The communications system allows wireless devices, e.g. mobile phones, PDSs, notebooks, etc. to send and receive text messages according to the messaging protocol such as the SMS protocol. SMS makes use of an SMSC which acts as a store-and-forward system for relaying short messages. Messages are stored in the network until the recipient becomes available, so a user can receive or transmit an SMS message at any time. In order to locate the destination device, the SMSC is further configured to interrogate an HLR for routing information.

SMS provides a mechanism for transmitting short messages via the signalling component of the communication system. It makes use of the signaling system no.7 (SS7) mobile application part (MAP). MAP is an application-layer protocol for accessing the GSM/UMTS network nodes (e.g. the HRL, VLR, MSC, Serving GPRS Support Node, etc.) and uses the transaction capabilities application part (TCAP) component of the SS.7 protocol. The Signalling Connection and Control Part (SCCP), a transport protocol of the SS.7 protocol stack, is used for routing and flow control between the GSM/UMTS network nodes.

The communications system 100 further comprises a router 116 (a signal transfer point (STP) in SS.7 terminology), which uses MAP screening to relay all MT/SMs of any subscriber registered with the advertisement service to a content service center (CSC) 118. MAP screening allows routing on the basis of the MAP operation. In one embodiment the CSC may comprise an MT/SM proxy comprising an content insertion module which is configured to add content, e.g. advertisement content, to the MT/SM. To that end, the CSC may comprise one or more content servers comprising one or more content databases 120 for providing content to the MT/SM proxy. When adding the content to the text message originating from the SMSC, the content insertion module checks whether the size of the content-extended text message exceeds a predetermined maximum length. If the maximum is exceeded, the MT/SM proxy triggers the concatenated SMS feature in the CSC in order to deliver the content-extended text message in a series of concatenated MT/SMs to the recipient. Further, the content insertion module is arranged to resolve undesired feature interactions between the advertisement insertion feature and the concatenated SMS feature. The CSC comprising the content insertion module thus enables content to be inserted in all messages delivered to a recipient registered with the service without requiring changes to the infrastructure of the messaging communication network.

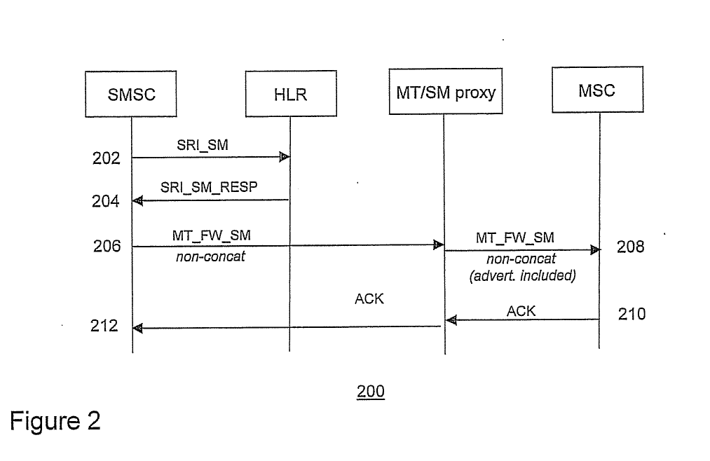

The CSC according to the invention may be implemented as a single network element, comprising one or more processors for executing code portions a software program product which provides the functionality of the content insertion module and which provides an interface with the one or more content servers comprising one or more content databases. Alternatively, the CSC may be implemented as a distributed system comprising various network elements and software programs. Ways of resolving these undesired service (feature) interactions are described hereunder in more detail with reference to FIGS. 2-5.

FIG. 2 depicts a flow diagram for delivery of a MT/SM from the SMSC to the SMC of the recipient in a communication system as illustrated in FIG. 1. The transmission of the MT/SM comprises two phases. In a first phase the SMSC requests information of the recipient from an HLR by sending a MAP Send Routing Information for Short Message (SRI_SM) to the HLR (step 202). In response the HLR sends the requested information, which comprises the location of the terminal of the recipient, such as the address of the MSC and alternative identifications of the terminal such as the local mobile station identifier (LMSI) and/or the international mobile station identifier (IMSI), back to the SMSC (step 204).

In the second phase, the SMSC delivers the text message to the MSC associated with the recipient using the MAP Mobile Terminated Forward Short Message (MT_FWD_SM). The router 116, which is configured to relay MAP MT_FWD_SM messages using MAP screening, directs the MT_FWD_SM message to the MT/SM proxy (step 206). The content insertion module of the CSC adds an advertisement to the text message received in the MT/SM and subsequently checks whether the total length of the extended-text message, i.e. the original text message and the added content, exceeds the maximum. If the maximum is not exceeded, the content-extended text message is sent as a MT/SM by the SMSC to the MSC of the destination device using a MT_FWD_SM message (step 208). If the MT_FWD_SM message is successfully received by the SMC, it sends a delivery acknowledgement(ACK) back to the MT/SM proxy (step 210), which subsequently forwards the ACK back to the SMSC (step 212). For authorized delivery of a text message, the time span between the two phases is typically in the range between a few seconds and several minutes.

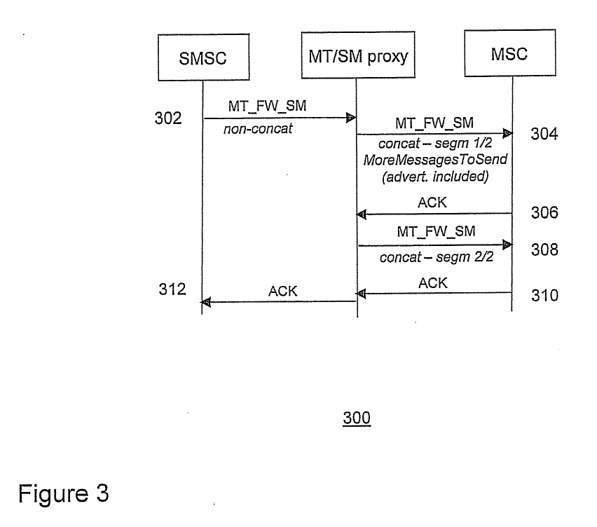

The process flow 200 depicted in FIG. 2 applies to the situation wherein the length of the content-extended text message does not exceed the maximum length defined in the relevant telecommunication standard. FIG. 3 depicts a process flow 300 between the' SMSC, the MT/SM proxy in the CSC and the MSC of the recipient according to another embodiment of the invention.

The process flow starts with the SMSC sending a single (non-concatenated) MT/SM to the MT/SM proxy (step 302). After reception of the MT/SM, the content insertion module retrieves content from a content server. Thereafter, the content insertion functions checks whether the total length of the retrieved advertisement content and the text message in the non-concatenated MT/SM exceeds the maximum allowable payload. If is too large for a single non-concatenated short message, it activates the concatenation feature in the MT/SM proxy to divide the extended text message into two segments wherein each segment has a size which is equal to or smaller than the maximum allowable length.

Thereafter, the MT/SM Proxy sends the first concatenated MT/SM comprising the first segment in a first MT_FWD_SM message to the MSC of the recipient (step 304). In order to allow the destination device to assemble the content segments into a complete text message, each concatenated MT/SM comprises a header that comprises a concatenation information block containing the total number of segments forming the content-extended text message and a segment number for identifying a particular segment of the content-extended text message. In this particular embodiment, the header of the first concatenated MT/SM indicates that the message comprises segment number one of the two segments forming the message.

If the transmission of the first concatenated MT/SM fails, the MT/SM proxy returns a NAK message to the SMSC indicating failure of the delivery and it will not attempt to send the second concatenated message to the MSC.

If the transmission of the first concatenated message is successful, the MSC sends an ACK message back to the MT/SM proxy (step 306). In response to the ACK, the MT/SM proxy sends the second concatenated MT/SM comprising the second segment in a second MT_FWD_SM message to the MSC (step 308). If the second concatenated MT/SM is successfully received by the MSC, an ACK is sent back to the MT/SM proxy (step 310), which subsequently forwards the ACK to the SMSC (step 312). This way the SCMC is informed that the message has been successfully sent to the destination device. If the transmission of the second concatenated MT/SM fails, the MT/SM proxy returns a NAK message to the SMSC.

From the process flow illustrated in FIG. 3 it follows that the MT/SM proxy only returns an ACK in response to an incoming MT/SM when the full content-extended text message, formed by the first and second content segments contained in first and second concatenated MT/SM respectively, is successfully sent to the MSC. When the message or part of the message does not get delivered, the MT/SM proxy returns a NAK.

The SMSC expects the ACK to arrive within a certain time period after having sent the (non-concatenated) MT/SM to the CSC. If the ACK is not received in time, the SMSC considers the transmission of the MT/SM to have failed. In that case the

SMSC will initiate a further delivery attempt at a later point in time. However, the SMSC is not aware of the fact that the content-extended text message is sent in a series concatenated MT/SMs to the MSC. Hence, as sending the content-extended text message in two or more concatenated MT/SMs introduces a certain delay in the transmission of the ACK to the SMSC, it is important to deliver the concatenated MT/SMs as fast as possible.

This problem is solved by forcing the communication channel between the SMSC and the MSC to remain open after successful delivery of the first MT_FWD_SM message. To that end the first MT_FWD_SM message sent by the CSC to the MSC includes the MoreMessagesToSend flag. This binary flag keeps the dialog (i.e. the communication channel) between the SMSC and the MCS open so that fast delivery of the concatenated MT/SMs is achieved. The same applies to the situation wherein the content size requires more than one additional concatenated MT/SM: during the subsequent transmission of the series of concatenated MT/SMs the communication channel is kept open by the content insertion module inserting the MoreMessagesToSend flag into the MAP MT_FWD_SM messages used for sending the concatenated MT/SMs to the MSC.

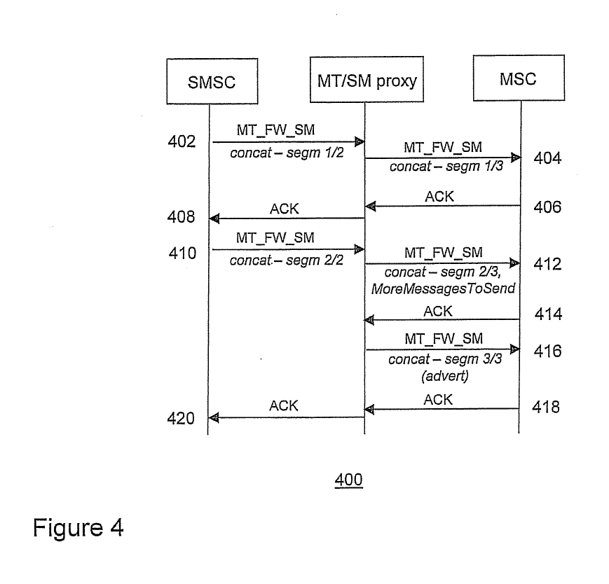

FIG. 4 depicts a process flow 400 of a further embodiment of the invention. In this embodiment the text message is sent to the SMSC in a series of concatenated text messages. In response, the SMSC sends the concatenated text messages, in this case two concatenated MT/SMs, to the CSC, wherein the MT/SM proxy in the CSC adds a further concatenated TM/SM comprising the advertisement content to the series of concatenated TM/SMs comprising the text message.

When sending a series of concatenated MT/SM, an SMSC only sends the subsequent MT/SM in an MT_FWD_SM message to the MSC if it has received an ACK from the MSC that the earlier MT/SM has been successfully received by the MSC. SMSCs maintain a transmit window of one: at any point in time, the SMSC has a maximum of one MT/SM delivery attempt per recipient in progress. Further, the SMSC composes a billing record upon receipt of an ACK associated with a MT_FWD_SM message sent to the MSC. Acknowledging an MT_FWD_SM thus results in an subscriber getting charged. Hence, due to these constrains set by the SMSC, it is normally not feasible for the CSC to first collect the full series of concatenated MT/SMs, add the advertisement content and subsequently send the series of concatenated MT/SM to the MSC of the recipient.

This problem is solved by the process flow depicted in FIG. 4. In the first step 402 of the flow diagram a first concatenated MT/SM comprising a first segment of a text message is sent in a first MT_FWD_SM message to the MT/SM proxy. The MT/SM proxy forwards the first concatenated MT/SM to the MSC in a second MT_FWD_SM message (step 404). After successful reception of the first MT_FWD_SM message an ACK is returned via the MT/SM proxy to the SMSC (steps 406 and 408). Thereafter, the second concatenated MT/SM comprising the second (and last) segment of the text message is sent in a third MT_FWD _SM message to the MT/SM proxy (step 410). Upon receipt of this second concatenated MT/SM, the MT/SM proxy retrieves a piece of content from a content server and inserts the content into a further MT/SM comprising. Thereafter using the concatenated SMS feature, the CSC sends the second concatenated MT/SM originating from the SMSC and the further MT/SM comprising the content for extending the text are sent by the MT/SM proxy as a series of concatenated MT/SMs to the MSC of the recipient. In this case, the last concatenated MT/SM comprises the added advertisement content (steps 412-416).

In the process flow of FIG. 4 the text message originating form the SMSC is sent in two concatenated MT/SMs to the MT/SM proxy and the content-extended text message is sent in three concatenated MT/SMs to the MSC. For that reason, the content insertion module in the MT/SM proxy is adapted to modify the total number of segments in the concatenation information block of the first concatenated MT/SM transmitted by the SMSC to the MT/SM proxy from two to three segments before sending it to the SMC. The same modification is performed in the concatenation information block of the second concatenated MT/SM originating from the SMSC. The content is sent in a third concatenated MT/SM comprising a concatenation information block indicating that the content is sent as the third (and last) segment of the three segments forming the content-extended text message. Modifying the total segments data field in the concatenation information block of the MT/SM messages is required to allow the recipient to correctly assess and construct a complete contend-extended text message from the received concatenated MT/SMs.

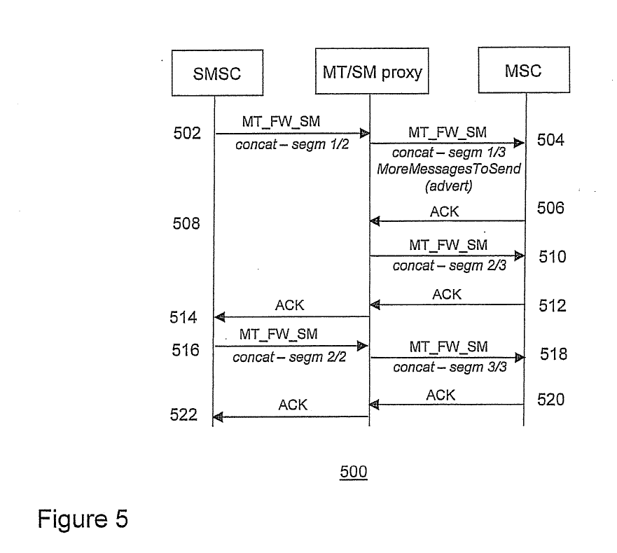

FIG. 5 depicts a variant of the process flow depicted in FIG. 4. In this process flow 500 a text message is sent to the MT/SM proxy using two MT/SMs and the content-extended text message is sent to the MSC using three concatenated MT/SMs. In this case however, the first concatenated MT/SM send the SMC comprises the content.

In response to the receipt of first concatenated MT/SM originating from the SMSC, the MT/SM proxy inserts the advertisement content in an MT/SM and sends the content in a first concatenated MT/SM to the MSC of the recipient. The content thus forms the first segment of the three segments associated with the content-extended text message. In a subsequent transmission, the first segment of the text message in the first concatenated MT/SM originating from the SMSC is sent in a second concatenated MT/SM comprising the second segment of the three segments associated with the content-extended text message. Hence, in the case where the content is located in the head of the content-extended text message, the content insertion module in MT/SM proxy is configured to adjusts both the total segment data field as well as the segment number data field in the concatenation information block of the MT/SM messages. For example in FIG. 5, the first MT/SM originating from the SMSC comprising first concatenation information (segment number=1 and total number of segments=2) is send by the MT/SM as a second concatenated MT/SM comprising second concatenation information (seyment number=2 and total number of segments=3). Hence, in the case where the content is positioned at the head of the content-extended text message, the MT/SM proxy modifies both the segment number and the total number of segments such that the terminal of the recipient is able to construct the content-extended message from the three concatenated MT/SMs.

It is to be understood that any feature described in relation to any one embodiment may be used alone, or in combination with other features described, and may also be used in combination with one or more features of any other of the embodiments, or any combination of any other of the embodiments. Furthermore, it is to be understood that the invention also applies to related SMS type services such as the Enhanced Messaging Service (EMS), a further development of SMS as described for example in ETSI/3GPP TS. Equivalents and modifications not described above may also be employed without departing from the scope of the invention, which is defined in the accompanying claims.

What is claimed is:

1. A method for extending a text message with content, the text message being sent by a mobile terminal via a Short Message Service Center (SMSC) of a communications system to a recipient, the communications system further comprising a Content Service Center (CSC), the method comprising:
receiving at the CSC the text message originating from the SMSC;
generating a content-extended text message by adding at least one piece of content to at least a part of the text message; and
sending, from the CSC, the content-extended text message depending on the size of the content-extended text message in one or more mobile terminated short messages (MT/SM) to the recipient.

2. The method according to claim 1, comprising:
receiving the text message in a single MT/SM;
if the content-extended text message is exceeding a predetermined maximum size, dividing the content-extended text message into two or more segments, each segment being smaller than the predetermined maximum size; and
sending the segments in two or more concatenated MT/SMs, preferably using MAP MT_FW_SM messages, to the recipient.

3. The method according to claim 2, wherein the communications system further comprises a mobile switching network element, and wherein during the sending of the two or more concatenated MT/SMs from CSC to a mobile switching network element, the communication channel between the CSC and the mobile switching network element is kept open.

4. The method of claim 3 wherein the mobile switching network element comprises a mobile switching center.

5. The method according to claim 3, wherein the communication channel is kept open by the SCS sending a flag indicating that a further concatenated MT/SM will be sent to the network switching element.

6. The method according to claim 5, wherein the flag comprises a MoreMessagesToSend flag sent in a MAP MT_FW_SM message comprising a concatenated text message to the network switching element.

7. The method according to claim 2, wherein the comprising sending, by the CSC, an acknowledgement (ACK) to the SMSC if the two or more concatenated MT/SMs are successfully received by the recipient and sending a NAK if the transmission of one of the two or more concatenated MT/SMs was unsuccessful.

8. The method according to claim 2, comprising:
receiving a concatenated MT/SM originating from the SMSC, the concatenated MT/SM comprising a segment number identifying the part of the text message contained in the concatenated MT/SM and the total number of segments forming the text message sent to the SMSC;
forming at least one further MT/SM comprising the content for extending the text message; and
sending the at least one further MT/SM and the concatenated MT/SM originating from the SMSC to the recipient as a series of concatenated MT/SMs, wherein the concatenation information of said concatenated MT/SMs is adapted such that the terminal of the recipient is capable of assembling the segments into a complete content-extended text message.

9. The method according to claim 8, wherein the adaptation of the concatenation information includes increasing the total number of segments and, optionally, increasing one or more segment numbers when the text message is extended by adding content to the head of the text message.

10. The method according to claim 1, wherein the communications system further comprises a network routing element, the method further comprising:
receiving at the network routing element a signalling message from the SMSC, the signalling message containing mobile application part (MAP) and signalling connection control part (SCCP) information; and
routing the signalling message to the SCS on the basis of predetermined MAP and/or SCCP information, preferably on the basis of the MAP MT_FWD_SM message.

11. The method according to claim 1, wherein the content comprises an advertisement and/or news flashes, horoscopes, RSS feed messages or any other pieces of information of commercial value.

12. A communications system for extending the payload of a text message sent by a subscriber from a mobile terminal to a recipient, the system comprising:
a Short Message Service Center (SMSC);
a mobile switching network element associated with the terminal of the recipient; and
a Content Service Center (CSC) for extending a text message originating from the SMSC with content, wherein the SCS is configured to generate a content-extended text message by adding at least one piece of content to at least a part of the text message and wherein the CSC is configured to send the content-extended text message in one or more MT/SMs via the mobile switching network element to the terminal of the recipient.

13. The communications system of claim 12 comprising a network routing element for routing text messages originating from the SMSC to the CSC.

14. A content service center for extending the a text message with content, the content service center comprising:
a receiver for receiving a text message in one or more MT/SMs originating from the SMSC;
a content server interface for retrieving content from a content server;
a content module configured for extending the text message with content by adding at least one piece of content to at least a part of the text message; and
a transmitter for sending the content-extended text message in one or more MT/SMs to the recipient.

15. The content service center according to claim 14, wherein the content module is configured to divide—if the content-extended text message is exceeding a predetermined maximum size—the content-extended text message into two or more segments, each segment being smaller than the predetermined maximum size and to send the segments in two or more concatenated MT/SMs to the recipient.

16. The content service center according to claim 15, wherein the two or more concatenated SMs comprise MAP MT_FW_SM messages.

17. The content service center according to claim 14, wherein the content service center is configured to send two or more concatenated MT/SMs via a mobile switching network element to the recipient; and, to keep—during the sending of the two or more concatenated MT/SMs—the communication channel between the CSC and the mobile switching network element open.

18. The content service center according to claim 17, wherein the content service center is configured to keep the communication channel between the CSC and the mobile switching center open using a MoreMessagsToSend flag sent in a MAP _{—MT}_FSM message sent to the network element.

19. The content service center according to claim 14, wherein the content service center is configured to:
receive a concatenated MT/SM originating from the SMSC, the concatenated MT/SM comprising a segment number identifying the part of the text message contained in the concatenated MT/SM and the total number of segments forming the text message sent to the SMSC;
form at least one further MT/SM comprising the content for extending the text message; and
send the at least one further MT/SM and the concatenated MT/SM originating from the SMSC to the recipient as a series of concatenated MT/SMs, wherein the concatenation information of said concatenated MT/SMs is adapted such that the terminal of the recipient is capable of assembling the segments into a complete content-extended text message.

20. A non-transitory computer readable medium having stored thereon an executable instructions that when executed by the processor of a computer control the computer to perform steps comprising:
receiving at the CSC the text message originating from the SMSC;
generating a content-extended text message by adding at least one piece of content to at least a part of the text message; and
sending, from the CSC, the content-extended text message depending on the size of the content-extended text message in one or more mobile terminated short messages (MT/SM) to the recipient.
